(19) United States
(12) Patent Application Publication
(10) Pub. No.: US 2026/0268926 A1
(43) Pub. Date: Sep. 10, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Sojung CHOI, Tokyo (JP)

(73) Assignee: NEC Corporation, Minato-ku, Tokyo (JP)

(21) Appl. No.: 18/876,353

(22) PCT Filed: Jul. 25, 2022
(86) PCT No.: PCT/JP2022/028659

§ 371 Date: Dec. 18, 2024

(51) Int. Cl. G10L 25/63; G06Q 10/109; G06T 11/10; G10L 15/08

(52) U.S. Cl. CPC G10L 25/63; G06Q 10/1097; G06T 11/10; G10L 15/08; G10L 2015/088

(57) ABSTRACT

An information processing apparatus (100) includes: a storage processing unit (102) that stores an emotion analysis result of a subject in association with a category of a task in which the subject is engaged in a case where the subject becomes an analysis target of the emotion analysis result; and a display processing unit (104) that displays, on a screen displaying schedules of the subject, schedules by category of a task which is planned to be performed or has been previously performed, in association with an emotion analysis result related to the category of the task.

### TECHNICAL FIELD

The present invention relates to an information processing apparatus, an information processing method, and a medium.

### BACKGROUND ART

Patent Document 1 describes a system predicting a future level of a specific emotion of a subject. The system described in this Patent Document 1 includes: an accumulation unit that accumulates an emotion history in which a level of a specific emotion generated based on an action history of a user acquired from a submission of the user on a social networking service (SNS), or the like, the date and time, and the position when and where the specific emotion is occurred, and a keyword related to occurrence of the specific emotion are associated with each other; and a control unit that predicts a future level of a specific emotion of the user, based on a future schedule of the user, and a level of the specific emotion stored as the emotion history and a keyword related to occurrence of the level of the specific emotion.

Further, Patent Document 2 describes a technology for suitably examining the magnitude of stress received by a subject. An information processing apparatus described in this Patent Document 2 generates a mathematical expression allowing conversion of a heartbeat-based stress value into a subjective stress value for a task, stores a stress weight and an offset value that constitute the mathematical expression, generates and stores a threshold value for the subjective stress value for the task, estimates the subjective stress value for each task for each week, based on the heartbeat-based stress value, by using the generated mathematical expression, determines whether the estimated subjective stress value is equal to or greater than the threshold value for each task, and in a case where a task whose estimated subjective stress value is equal to or greater than the threshold value exists, outputs an alert for the task whose estimated subjective stress value is equal to or greater than the threshold value.

### RELATED DOCUMENTS

Patent Document 1: Japanese Patent Application Publication No. 2020-177696
Patent Document 2: Japanese Patent Application Publication No. 2022-1115

### SUMMARY OF INVENTION

### Technical Problem

The technology described in Patent Document 1 described above assumes that a user recognizes a degree of happiness at a predetermined time at a destination of a business trip or a midway point by checking happiness forecasts throughout the country on the morning when the user makes the business trip and makes preparations in advance. Further, in the technology described in Patent Document 2 described above, an enterprise can provide suitable support to employees by quantifying stress received by a subject during a task and issuing an alert in a case where the stress exceeds a threshold value. In other words, neither of the technologies described in Patent Documents described above assumes estimating the emotion of a subject for each task and visualizing the emotion of the subject for each task on either of a past task schedule and a future task schedule of the subject.

Further, neither of the technologies described in Patent Documents described above assumes visualizing a keyword extracted by processing a conversation voice of a subject during a task and the emotion of the subject during the task in association with each other. On the other hand, the present inventor has examined estimating the emotion of a subject for each task, visualizing the emotion of the subject for each task on at least one of a past task schedule and a future task schedule of the subject, and visualizing a keyword extracted by processing a conversation voice during a task and the emotion of the subject during the task in association with each other.

The present invention has been made in view of the aforementioned circumstances, and an object of the present invention is to provide an information processing apparatus, an information processing method, and a medium that facilitate recognition of an effect of a task of a subject on a mental state by visualizing the emotion of the subject during the task.

### Solution to Problem

According to an aspect of the present invention, there is provided an information processing apparatus including:
a storage processing unit that stores an emotion analysis result of a subject into a storage unit in association with a category of a task in which the subject is engaged in a case where the subject becomes an analysis target of the emotion analysis result; and
a display processing unit that displays, on a screen displaying a schedule of the subject, schedules by category of the task which is planned to be performed or has been previously performed, in association with the emotion analysis result related to a category of the task.

According to an aspect of the present invention, there is provided an information processing apparatus including:
a storage processing unit that stores an emotion analysis result of a subject into a storage unit in association with a category of a task in which the subject is engaged in a case where the subject becomes an analysis target of the emotion analysis result;
an extraction unit that extracts, by processing a conversation voice of the subject during engagement in the task being an analysis target of the emotion analysis result, a keyword which includes at least one of a word and a phrase included in the conversation voice; and
a display processing unit that displays a screen including information in which a classification of an emotion of the subject for the task is associated with the keyword included in the conversation voice during engagement in the task.

According to an aspect of the present invention, there is provided an information processing method including,
by one or more computers:
storing an emotion analysis result of a subject into a storage unit in association with a category of a task in which the subject is engaged in a case where the subject becomes an analysis target of the emotion analysis result; and
displaying, on a screen displaying a schedule of the subject, schedules by category of the task which is planned to be performed or has been previously performed, in association with the emotion analysis result related to a category of the task.

According to an aspect of the present invention, there is provided an information processing method including,
by one or more computers:
storing an emotion analysis result of a subject into a storage unit in association with a category of a task in which the subject is engaged in a case where the subject becomes an analysis target of the emotion analysis result;
extracting, by processing a conversation voice of the subject during engagement in the task being an analysis target of the emotion analysis result, a keyword which includes at least one of a word and a phrase included in the conversation voice; and
displaying a screen including information in which a classification of an emotion of the subject for the task is associated with the keyword included in the conversation voice during engagement in the task.

According to an aspect of the present invention, there is provided a computer-readable medium storing a program for causing a computer to execute:
a procedure for storing an emotion analysis result of a subject into a storage unit in association with a category of a task in which the subject is engaged in a case where the subject becomes an analysis target of the emotion analysis result; and
a procedure for displaying, on a screen displaying a schedule of the subject, schedules by category of the task which is planned to be performed or has been previously performed, in association with the emotion analysis result related to a category of the task.

According to an aspect of the present invention, there is provided a computer-readable medium storing a program for causing a computer to execute:
a procedure for storing an emotion analysis result of a subject into a storage unit in association with a category of a task in which the subject is engaged in a case where the subject becomes an analysis target of the emotion analysis result;
a procedure for extracting, by processing a conversation voice of the subject during engagement in the task being an analysis target of the emotion analysis result, a keyword which includes at least one of a word and a phrase included in the conversation voice; and
a procedure for displaying a screen including information in which a classification of an emotion of the subject for the task is associated with the keyword included in the conversation voice during engagement in the task.

### Advantageous Effects of Invention

The aspects of the present invention can provide an information processing apparatus, an information processing method, and a medium that facilitate recognition of an effect of a task of a subject on a mental state by visualizing the emotion of the subject during the task.

### BRIEF DESCRIPTION OF THE DRAWINGS

FIG. 1 It is a diagram illustrating an overview of an information processing apparatus according to an example embodiment.

FIG. 2 It is a flowchart illustrating an operation example of the information processing apparatus according to the example embodiment.

FIG. 3 It is a diagram illustrating an overview of an information processing apparatus according to an example embodiment.

FIG. 4 It is a flowchart illustrating an operation example of the information processing apparatus according to the example embodiment.

FIG. 5 It is a diagram conceptually illustrating an example of a system configuration of an information processing system according to an example embodiment.

FIG. 6 It is a diagram conceptually illustrating another example of the system configuration of the information processing system according to the example embodiment.

FIG. 7 It is a block diagram illustrating a hardware configuration of a computer implementing the information processing apparatus.

FIG. 8 It is a functional block diagram illustrating a logical configuration of the information processing apparatus according to the example embodiment.

FIG. 9 It is a diagram illustrating a data structure example of biometric information.

FIG. 10 It is a diagram illustrating a data structure example of task information.

FIG. 11 It is a diagram illustrating a data structure example of score history information.

FIG. 12 It is a diagram for illustrating an emotion estimation method using an arousal level and a harmony level.

FIG. 13 It is a diagram illustrating a data structure example of emotion analysis result information.

FIG. 14 It is a diagram illustrating an example of a schedule screen.

FIG. 15 It is a diagram illustrating an example of the schedule screen.

FIG. 16 It is a diagram illustrating a data structure example of task-by-task emotion information.

FIG. 17 It is a diagram illustrating an example of a task ranking screen.

FIG. 18 It is a flowchart illustrating an operation example of the information processing apparatus according to the example embodiment.

FIG. 19 It is a functional block diagram illustrating a logical configuration of an information processing apparatus according to an example embodiment.

FIG. 20 It is a functional block diagram illustrating a configuration example of a variant of the information processing apparatus according to the example embodiment.

FIG. 21 It is a diagram illustrating an example of a keyword ranking screen.

FIG. 22 It is a flowchart illustrating an operation example of the information processing apparatus according to the example embodiment.

FIG. 23 It is a flowchart illustrating processing of counting keywords.

FIG. 24 It is a diagram conceptually illustrating an example of a system configuration of an information processing system according to an example embodiment.

FIG. 25 It is a diagram illustrating an example of a report screen.

FIG. 26 It is a diagram illustrating an example of the report screen.

FIG. 27 It is a diagram illustrating a graph illustrating a distribution of the emotion of a user.

### EXAMPLE EMBODIMENT

Example embodiments of the present invention will be described below by using drawings. Note that in every drawing, similar components are given similar signs, and description thereof is included as appropriate. Further, in each of the following diagrams, a configuration of a part not related to the essence of the present invention is included and is not illustrated.

In the example embodiments, “acquisition” includes at least one item out of an apparatus getting data or information stored in another apparatus or storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or storage medium. Further, examples of the passive acquisition include reception of distributed (or, for example, transmitted or push notified) information. Furthermore, “acquisition” may refer to selective acquisition from received data or information, or selective reception of distributed data or information.

### Minimum Configuration Example 1

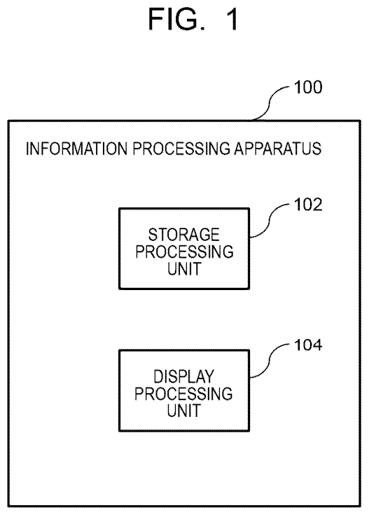

FIG. 1 is a diagram illustrating an overview of an information processing apparatus 100 according to an example embodiment. The information processing apparatus 100 includes a storage processing unit 102 and a display processing unit 104.

The storage processing unit 102 stores an emotion analysis result of a subject in association with the category of a task in which the subject is engaged in a case where the subject becomes an analysis target of the emotion analysis result.

The display processing unit 104 displays, on a screen displaying schedules of a subject, schedules by category of a task which is planned to be performed or has been previously performed, in association with an emotion analysis result related to the category of the task.

### Operation Example

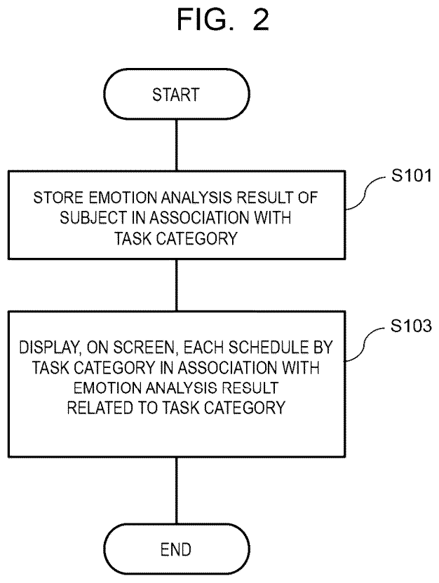

FIG. 2 is a flowchart illustrating an operation example of the information processing apparatus 100 according to the example embodiment.

The storage processing unit 102 stores an emotion analysis result of a subject in association with the category of a task in which the subject is engaged in a case where the subject becomes an analysis target of the emotion analysis result (Step S101).

The display processing unit 104 displays, on a screen displaying schedules of the subject, schedules by category of a task which is planned to be performed or has been previously performed, in association with an emotion analysis result related to the category of the task (Step S103).

Step S101 and Step S103 in this processing may be executed at different timings. For example, Step S101 is executed at a timing of acquiring the emotion analysis result of the subject and the category of the task, and Step S103 is executed at a timing of displaying the display screen for the schedules of the subject.

The storage processing unit 102 in the information processing apparatus 100 stores an emotion analysis result of a subject in association with the category of a task in which the subject is engaged in a case where the subject becomes an analysis target of the emotion analysis result.

The display processing unit 104 displays, on a screen displaying schedules of a subject, schedules by category of a task which is planned to be performed or has been previously performed, in association with an emotion analysis result related to the category of the task.

Thus, the information processing apparatus 100 facilitates recognition of an effect of a task of a subject on a mental state by visualizing the emotion of the subject during the task.

### Minimum Configuration Example 2

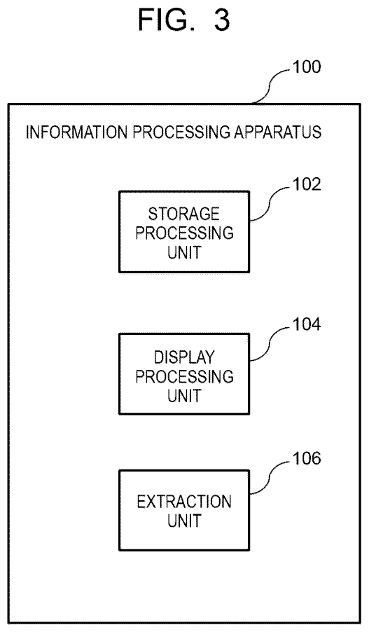

FIG. 3 is a diagram illustrating an overview of an information processing apparatus 100 according to an example embodiment. The information processing apparatus 100 includes a storage processing unit 102, a display processing unit 104, and an extraction unit 106.

The storage processing unit 102 stores an emotion analysis result of a subject in association with the category of a task in which the subject is engaged in a case where the subject becomes an analysis target of the emotion analysis result.

By processing a conversation voice of a subject in a case where the subject becomes an analysis target of an emotion analysis result, the extraction unit 106 extracts a keyword including at least one of a word and a phrase included in the conversation voice.

The display processing unit 104 displays, by category of a task, a screen including information in which a classification of the emotion of a subject for a task is associated with a keyword included in a conversation voice during engagement in the task.

### Operation Example

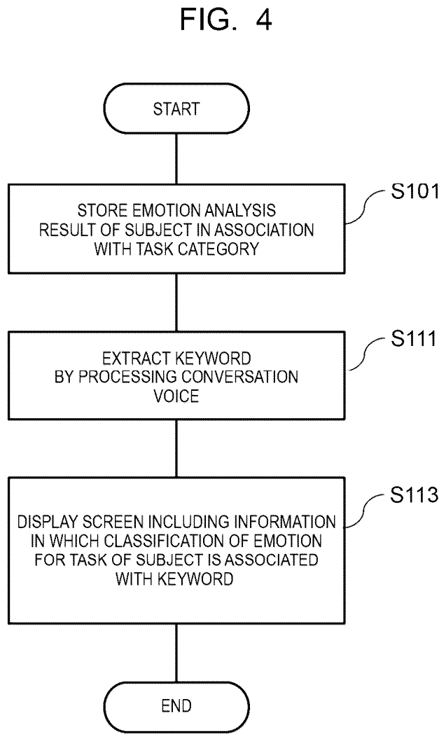

FIG. 4 is a flowchart illustrating an operation example of the information processing apparatus 100 according to the example embodiment.

The storage processing unit 102 stores an emotion analysis result of a subject in association with the category of a task in which the subject is engaged in a case where the subject becomes an analysis target of the emotion analysis result (Step S101).

The extraction unit 106 extracts a keyword including at least one of a word and a phrase included in a conversation voice of the subject in a case where the subject becomes an analysis target of the emotion analysis result by processing the conversation voice (Step S111).

The display processing unit 104 displays, by category of a task, a screen including information in which a classification of the emotion of the subject for a task is associated with a keyword included in a conversation voice during engagement in the task (Step S113).

Step S101, Step S111, and Step S113 in this processing may be executed at different timings. For example, Step S101 is executed at a timing of acquiring an emotion analysis result of a subject and the category of a task, Step S111 is executed at a timing of acquiring a conversation voice of the subject, and Step S113 is executed at a timing of displaying a display screen for the emotion analysis result of the subject.

The storage processing unit 102 in the information processing apparatus 100 stores an emotion analysis result of a subject in association with the category of a task in which the subject is engaged in a case where the subject becomes analysis target of the emotion analysis result. By processing a conversation voice of the subject in a case where the subject becomes an analysis target of the emotion analysis result, the extraction unit 106 extracts a keyword including at least one of a word and a phrase included in the conversation voice. The display processing unit 104 displays, by category of a task, a screen including information in which a classification of the emotion of the subject for a task is associated with a keyword included in a conversation voice during engagement in the task.

Thus, the information processing apparatus 100 facilitates recognition of an effect of a task of a subject on a mental state by visualizing the emotion of the subject during the task.

Detailed examples of the information processing apparatus 100 will be described below.

### First Example Embodiment

### System Overview

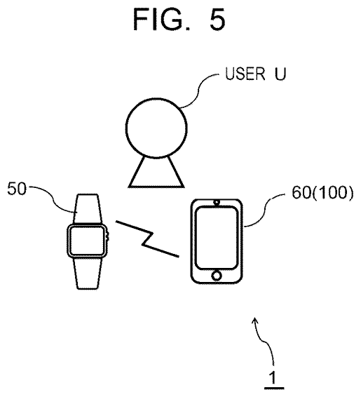

FIG. 5 is a diagram conceptually illustrating an example of a system configuration of an information processing system 1 according to an example embodiment.

The information processing system 1 includes an information processing apparatus 100 and a wearable terminal 50.

In this example, the information processing apparatus 100 is a user terminal 60 of a user U and is, for example, a computer such as a smartphone, a tablet terminal, or a personal computer. A pairing procedure between the user terminal 60 and the wearable terminal 50 is performed in advance in such a way as to allow communication using near-field communication (NFC).

The information processing system 1 assumes the user U as a subject of an emotion analysis, and for example, the user U is an employee of an enterprise. In this example, the user terminal 60 is possessed by the user U, and the wearable terminal 50 is lent to the user U by the enterprise. However, the user terminal 60 is not necessarily possessed by the user U and may be lent to the user U by the enterprise. Further, the wearable terminal 50 is not necessarily lent to the user U by the enterprise and may be possessed by the user U.

Since the wearable terminal 50 is lent to the user U by the enterprise in this case, the user U borrows the wearable terminal 50 and performs pairing between the wearable terminal 50 and the user terminal 60 upon arriving at the office, wears the wearable terminal 50 and engages himself/herself in a task, and releases the pairing between the wearable terminal 50 and the user terminal 60 and returns the wearable terminal 50 upon leaving the office. In other words, the wearable terminal 50 can be used in a shared manner among employees. Therefore, in a case where a working pattern is a work shift system, the wearable terminal 50 has only to be prepared for the number of employees in attendance per day instead of the number of employees.

The wearable terminal 50 measures biometric information of the user U and transmits the information to the user terminal 60. Various types of biometric information acquired by the wearable terminal 50 include a pulse, a heart rate, a body temperature, a blood pressure, an amount of activity, a pose, an electrocardiogram, a respiratory rate, a blood oxygen level, and a conversation voice and are not limited to the above.

The wearable terminal 50 is equipped with various sensors for measuring the pieces of biometric information. As for a conversation voice, a voice collected from a speaker of the wearable terminal 50 may be recorded, and the voice data may be transmitted to the user terminal 60. Further, the user terminal 60 may be continuously placed around the user U at work, and voice data collected by the speaker of the user terminal 60 may be used.

An application for using a service provided by the information processing system 1 is preinstalled on the user terminal 60 of the user U. The user U wears the wearable terminal 50, launches the application on the user terminal 60, and performs pairing between the wearable terminal 50 and the user terminal 60. Thus, the information processing apparatus 100 can achieve functions thereof on the user terminal 60.

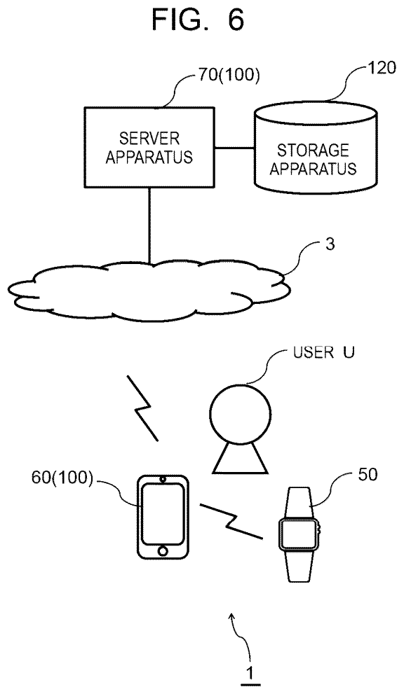

Furthermore, the information processing system 1 according to the example embodiment may have a configuration in FIG. 6. FIG. 6 is a diagram conceptually illustrating another example of a system configuration of the information processing system 1 according to the example embodiment. The information processing system 1 in this example further includes a server apparatus 70 in addition to the information processing system 1 according to the example embodiment in FIG. 5.

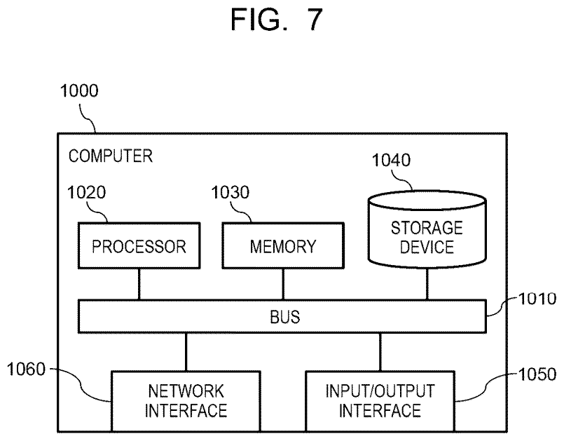

The server apparatus 70 is a server computer implemented by a computer 1000 in FIG. 7 to be described later. Further, the server apparatus 70 may include a web server. The user terminal 60 is connected to the server apparatus 70 through a communication network 3. The communication network 3 may be a network such as the Internet, or an enterprise network. The server apparatus 70 includes a storage apparatus 120. The storage apparatus 120 may be provided inside the server apparatus 70 or outside the server apparatus 70. In other words, the storage apparatus 120 may be hardware integrated with the server apparatus 70 or hardware separate from the server apparatus 70.

While the information processing apparatus 100 is implemented only by the user terminal 60 in the configuration example in FIG. 5, the information processing apparatus 100 is implemented by a combination of the server apparatus 70 and the user terminal 60 in the configuration example in FIG. 6. Further, it is assumed that the user U can use a service provided by the information processing system 1 by accessing the server apparatus 70 by using the user terminal 60. Therefore, the user U previously performs user registration and sets account information. In a case where the user U uses a service implemented by the information processing system 1, the user U logs into the information processing system 1 by using the account information.

The user U can use a service provided by the information processing system 1 by installing the application described above on the user terminal 60, launching the application, and logging into the information processing system 1. Alternatively, the user U may be able to use a service provided by the information processing system 1 by launching a predetermined browser on the user terminal 60, accessing a website for using the service provided by the information processing system 1, and logging in by using the account information.

### Hardware Configuration Example

FIG. 7 is a block diagram illustrating a hardware configuration of the computer 1000 implementing the information processing apparatus 100 (user terminal 60). Each of the wearable terminal 50 and the server apparatus 70 is also implemented by the computer 1000. Further, a manager terminal 80 described in an example embodiment to be described later is also implemented by the information processing apparatus 100.

The computer 1000 includes a bus 1010, a processor 1020, a memory 1030, a storage device 1040, an input/output interface 1050, and a network interface 1060.

The bus 1010 is a data transmission channel for the processor 1020, the memory 1030, the storage device 1040, the input/output interface 1050, and the network interface 1060 to transmit and receive data to and from each other. Note that the method for interconnecting the processor 1020 and other components is not limited to a bus connection.

The processor 1020 is a processor implemented by a central processing unit (CPU), a graphics processing unit (GPU), or the like.

The memory 1030 is a main storage implemented by a random-access memory (RAM) or the like.

The storage device 1040 is an auxiliary storage implemented by a hard disk drive (HDD), a solid-state drive (SSD), a memory card, a read-only memory (ROM), or the like. The storage device 1040 stores program modules for achieving functions of the information processing apparatus 100 (such as the storage processing unit 102, the display processing unit 104, the extraction unit 106, and an emotion analysis unit 110, a counting unit 112, an acquisition unit 114, and the like that are to be described later). By reading each program module into the memory 1030 and executing the program module by the processor 1020, each function related to the program module is achieved. Further, the storage device 1040 may store each piece of data in the storage apparatus 120 to be described later.

The program modules may be recorded on a medium. The medium on which the program modules are recorded includes a non-transitory tangible medium that can be used by the computer 1000, and a program code readable by the computer 1000 (processor 1020) may be embedded in the medium.

The input/output interface 1050 is an interface for connecting the computer 1000 to various types of input/output equipment. The input/output interface 1050 also functions as a communication interface performing short-distance wireless communication such as Bluetooth (registered trademark) or near-field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment (such as a display, a touch panel, an indicator, an operation button, a camera, a speaker, and a microphone in the user terminal 60; a display, a touch panel, an indicator, an operation button, a speaker, and a microphone in the wearable terminal 50; and a keyboard, a mouse, a speaker, a microphone, and a printer in the server apparatus 70) through the input/output interface 1050 or the network interface 1060.

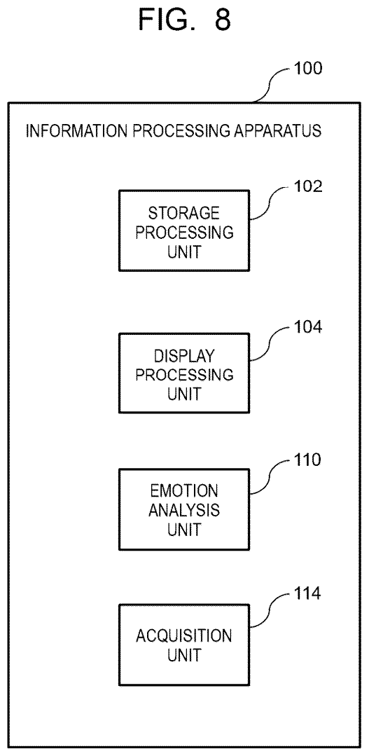

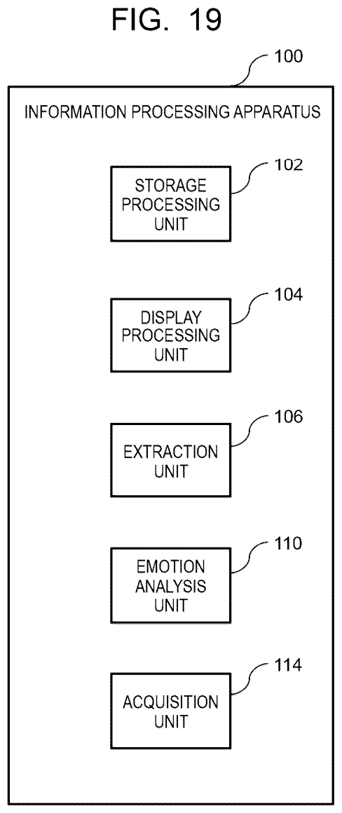

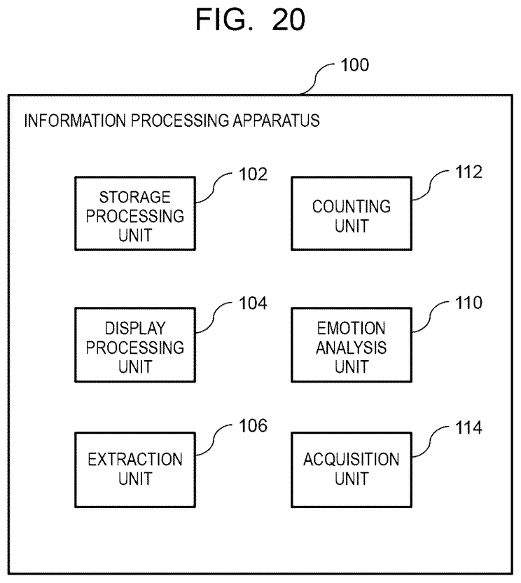

Each component in the information processing apparatus 100 according to each example embodiment in FIG. 1, FIG. 3, and FIG. 8, FIG. 19, and FIG. 20 that are to be described later is implemented by any combination of hardware and software of the computer 1000 in FIG. 7.

Then, it may be understood by a person skilled in the art that various modifications to the implementation method and the apparatus can be made. A functional block diagram illustrating the information processing apparatus 100 according to each example embodiment illustrates logical function-based blocks rather than a hardware-based configuration.

### Functional Configuration Example

FIG. 8 is a functional block diagram illustrating a logical configuration of the information processing apparatus 100 according to the example embodiment.

The information processing apparatus 100 includes a storage processing unit 102 and a display processing unit 104 that are the same as those in the information processing apparatus 100 in FIG. 1 and further includes an emotion analysis unit 110 and an acquisition unit 114.

The acquisition unit 114 acquires data for emotion analysis of a subject and acquires task information related to a task in which the subject is engaged in a case where the data for emotion analysis are acquired.

The data for emotion analysis include biometric information of a user U (subject) acquired from the wearable terminal 50 worn by the user U.

A timing at which biometric information is acquired from the wearable terminal 50 is not particularly limited. A certain amount of biometric information may be accumulated according to storage capacity on the wearable terminal 50, and biometric information for a predetermined period may be collectively transmitted. Biometric information may be transmitted in a case where a communication condition is good depending on communication status between the wearable terminal 50 and the user terminal 60, may be immediately transmitted every time biometric information is acquired, or may be transmitted every time a certain time elapses.

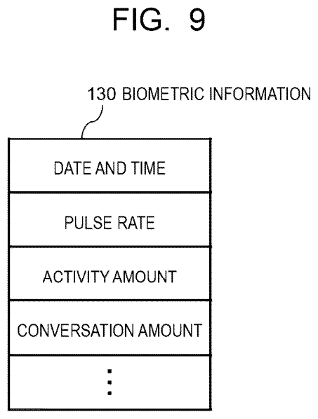

FIG. 9 is a diagram illustrating a data structure example of biometric information 130. Time information is stored in the biometric information 130 in association with biometric information such as a pulse rate, an amount of activity, and an amount of conversation. The biometric information 130 is stored in the memory 1030 or the storage device 1040 in the computer 1000 implementing the user terminal 60 or the server apparatus 70, or the storage apparatus 120.

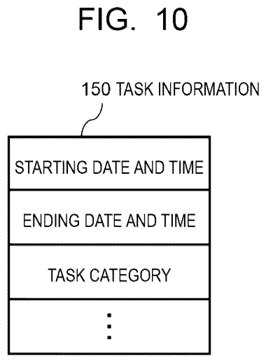

FIG. 10 is a diagram illustrating a data structure example of task information 150. The task information 150 includes schedule information during working hours of the user U. In this example, a starting time and an ending time for each category of a task are stored in association with each other. Categories of a task also include a break. Therefore, a starting time and an ending time of a break are also stored in the task information 150 in association with each other.

The task information 150 is stored in the memory 1030 or the storage device 1040 in the computer 1000 implementing the user terminal 60 or the server apparatus 70, or the storage apparatus 120.

A category of a task is not particularly limited and may be set as appropriate by the user U or a manager M managing the user U at an enterprise for which the user U works. Categories of a task may include not only classifications based on work types (a conference, a business trip to a customer site, new clientele cultivation, orientation for new employees, material preparation, report, and the like) but also classifications based on a predetermined project, a target product of the task, the field of the product, a client (an enterprise or a person in charge) being a target of the task, a team member of the task, a responsible person of the task, and the like. The information processing apparatus 100 may include an acceptance unit (unillustrated) that displays a user interface (UI) accepting setting of a task category on a predetermined operation screen (unillustrated) and accepts the setting.

Further, the task information 150 may be a schedule indicating a future plan, a schedule indicating an actual result of engagement by the user U, or both a plan and a result.

The emotion analysis unit 110 performs an emotion analysis of the user U by using data for emotion analysis of the user U acquired by the acquisition unit 114 from the wearable terminal 50 of the user U and outputs an emotion analysis result. For example, the emotion analysis result is output as a score value indicating the mental state of the user U.

Scores indicating mental states include a plurality of scores respectively indicating a plurality of types of mental states. As an example, the scores include scores respectively indicating an arousal level and a harmony level. For example, the arousal level is a value indicating a degree of arousal indicating a sleepy state; and a higher score value indicates a state of a higher degree of arousal, and a lower score value indicates a state of a higher degree of sleepiness. The harmony level is a value indicating an emotion such as comfort or discomfort; and a higher score value indicates a more comfortable state, and a lower score value indicates a more uncomfortable state.

For example, a score may be a value indicated by one of numerical value ranges of 0 to 100, −100 to +100, 0 to 1, and −1 to +1 but is not limited to the above.

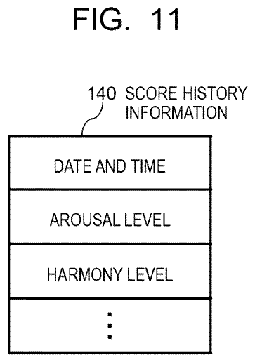

FIG. 11 is a diagram illustrating a data structure example of score history information 140. Time information and a score output by the emotion analysis unit 110 are stored in the score history information 140 in association with each other. The score history information 140 is stored in the memory 1030 or the storage device 1040 in the computer 1000 implementing the user terminal 60 or the server apparatus 70, or the storage apparatus 120.

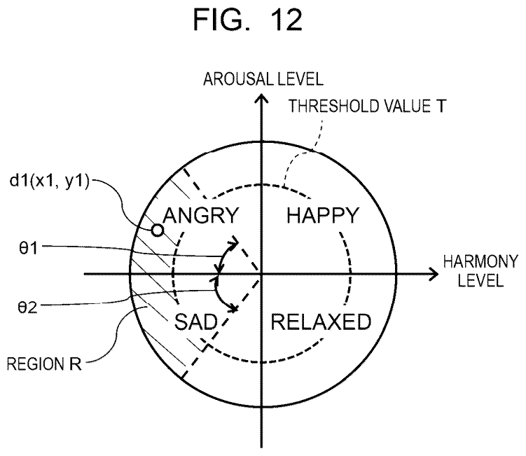

FIG. 12 is a diagram for illustrating an emotion estimation method using the arousal level and the harmony level.

In this example, the arousal level and the harmony level being two scores indicating mental states are indicated as coordinate axes, and four regions demarcated by the coordinate axes are respectively related to four emotion classifications of the user U. The four emotion classifications being “ANGRY,” “HAPPY,” “SAD,” and “RELAXED” in this example are respectively set by four coordinate regions. Then, in a case where the score value of the user U is within a range exceeding a threshold value T, the user U is estimated to have an emotion corresponding to the region.

Specifically, a score indicating the arousal level and a score indicating the harmony level are plotted on a graph in FIG. 12. The threshold value T is preset for at least one of the arousal level and the harmony level. The threshold value T is indicated by, for example, a value between 0 and 100 on the Y-axis being the arousal level in FIG. 12. Then, a region beyond a circle with a radius based on the threshold value and up to 100 on the Y-axis is a range for each emotion. In other words, in a case where a plot of a score is included in a region beyond the threshold value T, the user U (subject) is estimated to have an emotion corresponding to the region. For example, FIG. 12 indicates data d1 where a score y1 of the arousal level and a score x1 of the harmony level at a time t1 are plotted. The data d1 of the user U (subject) at this time are included in a region indicated as “ANGRY” beyond the threshold value T, and therefore the user U is estimated to have an emotion of anger. Note that the range of the threshold value T may not only be circular but also be elliptic. In other words, threshold values for the X-axis and the Y-axis may be different values.

Furthermore, the emotion analysis unit 110 according to the present example embodiment may estimate whether the emotion of the user U is included in the negative region and may determine a case of the user U being estimated to have a negative emotion. Whether the user U has a negative emotion may be determined by whether data d where scores of the arousal level and the harmony level of the user U are plotted are included in the “ANGRY” and “SAD” regions.

Furthermore, in a case where the data d where the scores of the arousal level and the harmony level of the user U are plotted are included in a hatched region in FIG. 12, the user U may be determined to have a particularly negative emotion. For example, the hatched region is a region extending in a shape of a fan with a predetermined angle θ1 from the minus side of the x-axis toward the y-axis in a plus direction in the “ANGRY” region of the negative emotion. Further, for example, the hatched region is a region extending in a shape of a fan with a predetermined angle θ2 from the minus side of the x-axis toward the y-axis in a minus direction in the “SAD” region of the negative emotion. Note that θ1 is set in a range of 0 to +90°, and θ2 is set in a range of 0 to −90°.

While the range of the negative emotion is indicated in a single-step level in this example, the range may be indicated in a plurality of levels in another example. For example, a region extending in a shape of a fan with an angle θ3 may be set in such a way as to be a range narrower than the region defined by the angle θ1 indicating the “ANGRY” region of the negative emotion. Then, the emotion analysis unit 110 may determine whether the user U has a stronger negative emotion, based on whether the data d are included in the region extending in a shape of a fan with the angle θ3. Furthermore, the storage processing unit 102 may store a level (indicating a height) of the negative emotion into emotion analysis result information 160.

Note that the angle θ3 is an angle less than the angle θ1.

Further, a positive emotion may also be determined by the emotion analysis unit 110 and be stored into the emotion analysis result information 160 by the storage processing unit 102, similarly to the negative emotion. For example, a positive emotion may be determined by whether the data d where the scores of the arousal level and the harmony level of the user U are plotted are included in the “HAPPY” and “RELAXED” regions. Further, a level of the positive emotion may be determined by whether the data d are included in a fan-shaped region indicated by a predetermined angle in the HAPPY“ and ”RELAXED“ regions, similarly to the negative emotion.

The storage processing unit 102 stores, as the emotion analysis result information 160, an emotion analysis result of the user U output by the emotion analysis unit 110 in association with the category of a task in which the user U is engaged in a case where the user U becomes an analysis target of the emotion analysis result. The category of the task in which the user U is engaged in a case where the user U becomes an analysis target of the emotion analysis result can be acquired from task information acquired by the acquisition unit 114.

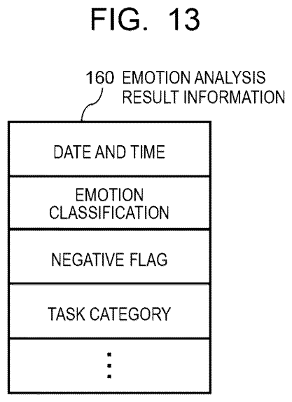

FIG. 13 is a diagram illustrating a data structure example of the emotion analysis result information 160. Time information, an emotion classification of the user U at the time of estimation by the emotion analysis unit 110, and a negative flag indicating whether the user U has a negative emotion (for example, “1” is set in a case where the user U is determined to have a negative emotion) are stored in the emotion analysis result information 160 in association with each other. Further, a positive flag indicating whether the user U has a positive emotion (for example, “1” is set in a case where the user U is determined to have a positive emotion) may be stored in the emotion analysis result information 160 in association with the above. Furthermore, a task category in which the user U is engaged at this time is stored in the emotion analysis result information 160 in association with the above. The emotion analysis result information 160 is stored in the memory 1030 or the storage device 1040 in the computer 1000 implementing the user terminal 60 or the server apparatus 70, or the storage apparatus 120.

The display processing unit 104 displays, on a screen displaying schedules of the user U, schedules by category of a task which is planned to be performed or has been previously performed, in association with an emotion analysis result related to the category of the task.

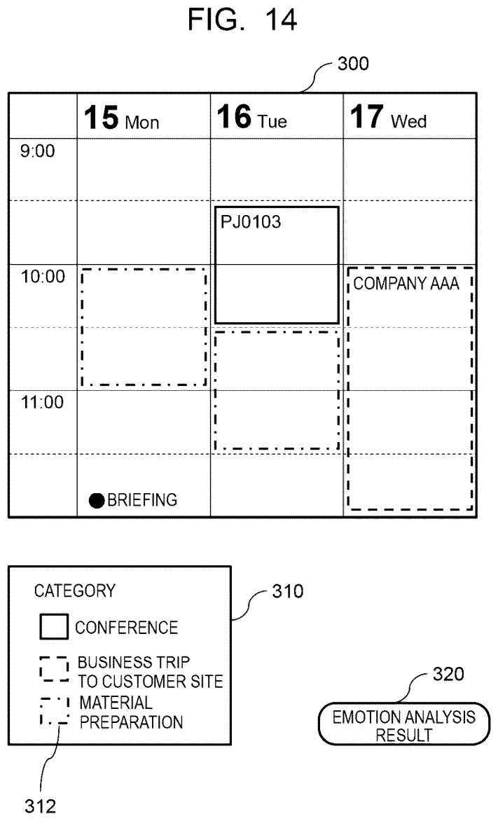

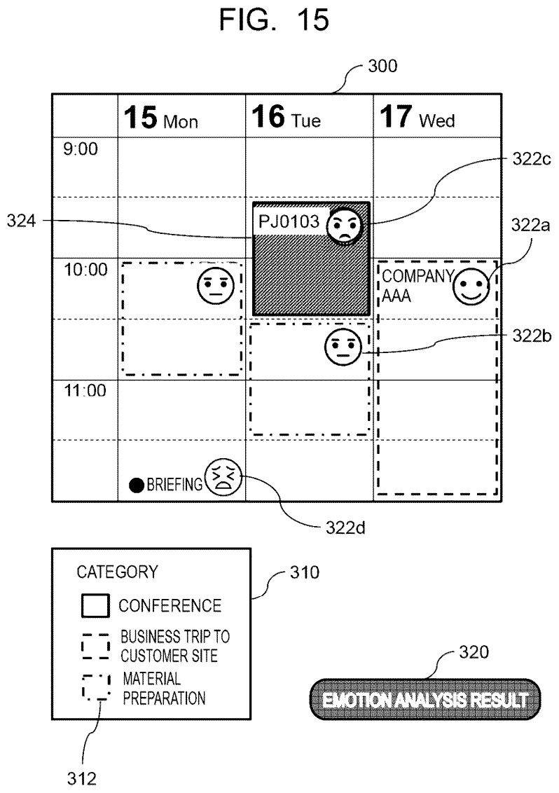

FIG. 14 and FIG. 15 are diagrams illustrating examples of a schedule screen 300. Each schedule screen 300 may be displayed by a display operation of the schedule screen 300 being selected from an operation menu. Alternatively, the schedule screen 300 may be automatically displayed on the user terminal 60 at a timing previously specified by the user U or the manager M (such as at 9 hours on workday).

FIG. 14 is an example of a screen not including an emotion analysis result. The schedule screen 300 displays schedules of the user U by task category. Note that the method for displaying schedules is not limited to the diagram, and various display modes may be considered. A legend list 310 includes a legend display part 312 and indicates a legend for each task category. The user U can enter and browse a schedule on the schedule screen 300.

Further, the manager M may be able to browse the schedule screen 300 in an example embodiment to be described later. Upon acceptance of depression of an emotion analysis result display button 320, the display processing unit 104 makes a transition to the schedule screen 300 in FIG. 15.

Schedules are displayed on a schedule screen 300 in FIG. 15 by category of a task which is planned to be performed or has been previously performed, in association with emotion analysis results related to the respective task categories. For example, the emotion analysis result display button 320 on the schedule screen 300 in FIG. 15 is displayed in a state of being reversed from the emotion analysis result display button 320 in FIG. 14 in order to indicate a selected state.

The display processing unit 104 displays schedules by category of a task in such a way as to allow distinction by a color or a display element 322 based on an emotion analysis result of the user U. In this example, emotion classifications of the user U are respectively indicated by four types of display elements 322. For example, a display element 322 is a mark of a face indicating an emotion by a facial expression. A display element 322a is a mark of a smiling face indicating the emotion classification “HAPPY.” A display element 322b is a mark of a straight face indicating the emotion classification “RELAXED.” A display element 322c is a mark of an angry face indicating the emotion classification “ANGRY.” A display element 322d is a mark of a crying face indicating the emotion classification “SAD.”

Furthermore, the display processing unit 104 performs a display color change 324 on the category of a task for which the user U has a strong negative emotion as a display element 322 in this example. The display color change 324 may be performed by a display color change with one of four colors respectively related to the four types of emotion or may be performed by a display color change only on a particularly strong emotion as is the case in this example. For example, the colors of “ANGRY” and “SAD” being negative emotion classifications may be respectively changed to red and purple, and the colors of “RELAXED” and “HAPPY” being positive emotion classifications may be respectively changed to green and yellow.

As for a past schedule, the emotion for which the user U has while performing a task is visualized on the schedule by thus distinguishably displaying the emotion of the user U for each task on a schedule. Therefore, for example, in a case where the user U is mentally exhausted, a task being the cause may be determined. Further, as for a future schedule, the emotion of the user U for each task is visualized, and therefore, for example, in a case where tasks for which the user U may have a negative emotion are concentratedly scheduled in a certain period, such an issue can be clearly recognized. Therefore, schedule adjustments such as sharing a task with another person and shifting a task schedule to another day can be more easily performed.

Further, visualization of the emotion of the user U for each task enables recognition of a task which the user U is good at. For example, a task for which the user U may have a positive emotion is highly likely to be a task which the user U is good at. Therefore, for example, the manager M can suitably assign a task in consideration of a task which the user U is good at (a task for which the user U may have a positive emotion) and a task which the user U is not good at (a task for which the user U may have a negative emotion).

The setting of the method for displaying an emotion analysis result by the display processing unit 104 may be changed by the user U or the manager M from a setting screen.

Examples of function allocation of the information processing apparatus 100 in the user terminal 60 and the server apparatus 70 are as follows.
(a1) All the functions are achieved by the user terminal 60 in the system configuration in FIG. 5 not including the server apparatus 70.

Examples of function allocation in the system configuration in FIG. 6 including the user terminal 60 and the server apparatus 70 are as follows.
(a2) The user terminal 60 achieves the function of acquiring biometric information from the wearable terminal 50 by the acquisition unit 114; and the server apparatus 70 achieves the function of acquiring biometric information from the user terminal 60 by the acquisition unit 114 and the functions of the emotion analysis unit 110, the storage processing unit 102, and the display processing unit 104. In other words, the user terminal 60 acquires biometric information from the wearable terminal 50 and transmits the information to the server apparatus 70; and the server apparatus 70 performs emotion analysis processing by using the biometric information received by the user terminal 60, stores and manages the information, causes the user terminal 60 to display the schedule screen 300, and cause the user U to browse.
(a3) The user terminal 60 achieves the functions of the acquisition unit 114, the emotion analysis unit 110, and the storage processing unit 102 and the function of transmitting an emotion analysis result and the category of a task to the server apparatus 70; and the server apparatus 70 achieves the function of recording an emotion analysis result and the category of a task received from the user terminal 60 by the storage processing unit 102 and the function of the display processing unit 104. In other words, the user terminal 60 performs processing up to association of an emotion analysis result with the category of a task; and the server apparatus 70 stores and manages information received by the user terminal 60, causes the user terminal 60 to display the schedule screen 300, and causes the user U to browse.

The emotion analysis result information 160 (emotion analysis result) may include, by task category, an emotion score indicating at least one of a degree of positiveness and a degree of negativeness of the emotion of the user U (subject) for a task.

For each task category, the emotion analysis unit 110 may determine an emotion score, based on an emotion analysis result of the user U by task category in a predetermined period. For example, the predetermined period may be set to any period such as a most recent one month, a half year, or one year. For example, the ratio of the time during which a score value indicating a mental state is included in the positive emotion region or the negative emotion region described above may be determined as an emotion score. More specifically, the ratio of the time during which the user U is estimated to have a positive emotion or a negative emotion to working hours may be determined as an emotion score.

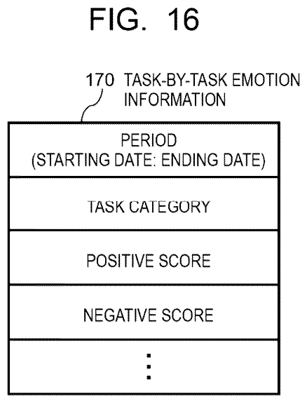

FIG. 16 is a diagram illustrating a data structure example of task-by-task emotion information 170.

A starting date and an ending date of a predetermined period are stored in the task-by-task emotion information 170 in association with at least one of a positive score and a negative score for each task category. The task-by-task emotion information 170 is stored in the memory 1030 or the storage device 1040 in the computer 1000 implementing the user terminal 60 or the server apparatus 70, or the storage apparatus 120.

The display processing unit 104 displays a screen indicating a rank of an emotion score of the user U for each task. A task ranking screen 330 may be displayed by a display operation of the task ranking screen 330 being selected from an operation menu.

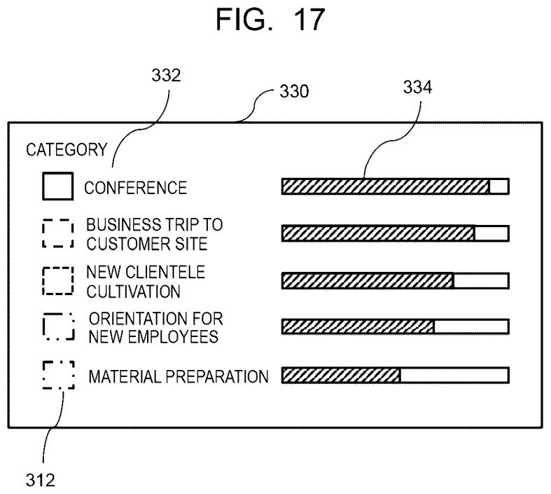

FIG. 17 is a diagram illustrating an example of the task ranking screen 330.

The task ranking screen 330 includes a category display part 332, a legend display part 312, and a score display part 334. For example, the display processing unit 104 arranges task categories in descending order of negative score, based on information stored in the task-by-task emotion information 170, and displays the categories on the task ranking screen 330. As for display switching between a negative score and a positive score, a switching operation may be accepted by a radio button (unillustrated) or the like.

Further, the display processing unit 104 displays, on the schedule screen 300 for schedules indicating future plans, in such a way as to allow distinction by a color or a display element being related to the category of a task and indicating at least one of a degree of positiveness and a degree of negativeness of the emotion of the user U for the task. For example, the shade of a color may be changed depending on a degree of each emotion. For example, as a degree of the emotion “ANGRY” increases, the color becomes darker red, and as a degree of the emotion “ANGRY” decreases, the color becomes lighter red.

As is the case with the schedule screen 300 in FIG. 15, the display processing unit 104 may refer to the task-by-task emotion information 170 and distinguishably display the display elements 322 and the display color changes 324, based on an emotion score related to the task category of a schedule.

### Operation Example

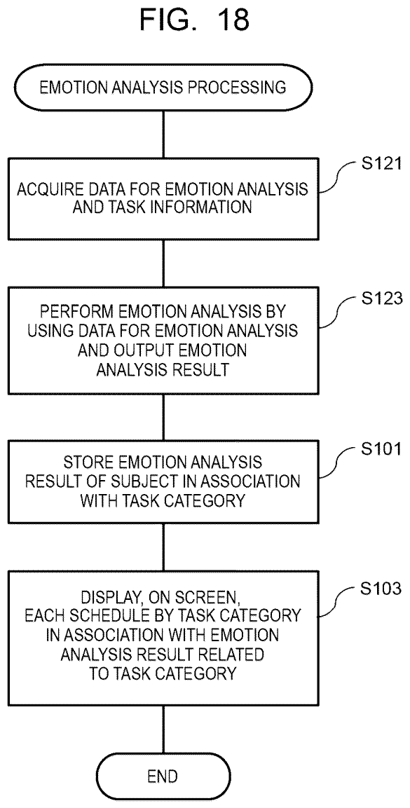

FIG. 18 is a flowchart illustrating an operation example of the information processing apparatus 100 according to the example embodiment.

The example of function allocation in (a1) will be described.

The flow in FIG. 18 includes Step S101 and Step S103 that are the same as those in the flow in FIG. 2 and further includes Step S121 and Step S123. Note that each step in the flowchart can be operated independently, and each step may be executed at a different timing as described above.

First, the acquisition unit 114 in the user terminal 60 acquires data for emotion analysis of a user U and acquires the task information 150 related to a task in which the user U is engaged in a case where the data for emotion analysis are acquired (Step S121).

The data for emotion analysis include biometric information of the user U acquired from the wearable terminal 50 worn by the user U. The acquired biometric information is stored as the biometric information 130 into the memory 1030 or the storage device 1040 in the user terminal 60 in association with time information. The time information is preferably a time at which the biometric information is measured by the wearable terminal 50 but may be a time at which the biometric information is received from the wearable terminal 50 or a time at which the biometric information is stored as the biometric information 130. The acquired task information 150 is stored into the memory 1030 or the storage device 1040 in the user terminal 60.

The emotion analysis unit 110 performs an emotion analysis of the user U by using the data for emotion analysis of the user U acquired from the wearable terminal 50 of the user U by the acquisition unit 114 and outputs an emotion analysis result (Step S123). For example, the emotion analysis result is output as a score value indicating the mental state of the user U. The output score value is stored into the memory 1030 or the storage device 1040 in the user terminal 60 as the score history information 140 in association with time information. The time information is time information in the biometric information 130 used for estimation of the score value.

The storage processing unit 102 stores the emotion analysis result of the user U as the emotion analysis result information 160 in association with the category of a task in which the user U is engaged in a case where the user U becomes an analysis target of the emotion analysis result (Step S101). The emotion analysis result information 160 in which the time information is associated with an emotion classification, a negative flag, and a task category as the emotion analysis result is stored into the memory 1030 or the storage device 1040 in the user terminal 60.

The display processing unit 104 displays, on the schedule screen 300 displaying schedules of the user U, schedules by category of a task which is planned to be performed or has been previously performed, in association with an emotion analysis result related to the category of the task (Step S103).

As described above, the information processing apparatus 100 according to the present example embodiment includes the storage processing unit 102, the display processing unit 104, the emotion analysis unit 110, and the acquisition unit 114. The acquisition unit 114 acquires data for emotion analysis of a user U and acquires task information related to a task in which the user U is engaged in a case where the data for emotion analysis are acquired. The emotion analysis unit 110 performs an emotion analysis of the user U by using data for emotion analysis of the user U acquired from the wearable terminal 50 of the user U by the acquisition unit 114 and outputs an emotion analysis result. The storage processing unit 102 stores an emotion analysis result of the user U output from the emotion analysis unit 110 as the emotion analysis result information 160 in association with the category of a task in which the user U is engaged in a case where the user U becomes an analysis target of the emotion analysis result. The display processing unit 104 displays, on the schedule screen 300 displaying schedules of the user U, schedules by category of a task which is planned to be performed or has been previously performed, in association with an emotion analysis result related to the category of the task.

Thus, the information processing apparatus 100 according to the example embodiment can facilitate recognition of an effect of a task of a subject on a mental state by visualizing the emotion of the subject during the task. Further, as for a past schedule, the emotion of the user U during a task is visualized on the schedule by distinguishably displaying the emotion of the user U for each task on a schedule by the display processing unit 104, as described above. Therefore, for example, in a case where the user U is mentally exhausted, a task being the cause may be determined. Further, as for a future schedule, the emotion of the user U for each task is visualized by the display processing unit 104, and therefore, in a case where tasks for which the user U may have a negative emotion are concentratedly scheduled in a certain period, such an issue can be clearly recognized. Therefore, schedule adjustments such as sharing a task with another person and shifting a task schedule to another day can be more easily performed.

Further, visualization of the emotion of the user U for each task enables recognition of a task which the user U is good at. For example, a task for which the user U may have a positive emotion is likely to be a task which the user U is good at. Therefore, for example, the manager M can suitably assign a task in consideration of a task which the user U is good at (a task for which the user U may have a positive emotion) and a task which the user U is not good at (a task for which the user U may have a negative emotion).

Thus, the user U falling into mental exhaustion due to a task can be prevented, and the user U receiving excessive stress due to a task can be recognized; and therefore, a suitable action can be taken, and a worsening of the mental state may be prevented.

Furthermore, the manager M can more easily recognize a task which the user U is good at and a task which the user U is not good at and can provide suitable training to the user U.

Further, ranking display by category of a task of the user U can be performed by the display processing unit 104; and therefore, in a case where a schedule of the task is prepared, excessive placement of a burden on the user U due to a task can be prevented by referring to the display.

### Second Example Embodiment

FIG. 19 is a functional block diagram illustrating a logical configuration of an information processing apparatus 100 according to an example embodiment.

The present example embodiment differs from the aforementioned example embodiment in being configured to display keywords included in a conversation voice of a user U by task category in association with the classification of the emotion of the user U during the task. Note that the configuration according to the present example embodiment may be combined with at least one of configurations according to other example embodiments without contradicting each other.

### System Overview

An information processing system 1 according to the present example embodiment may have one of the system configuration in FIG. 5 and the system configuration in FIG. 6 that are described in the aforementioned example embodiment.

### Functional Configuration Example

An information processing apparatus 100 includes a storage processing unit 102, a display processing unit 104, and an extraction unit 106 that are the same as those in the information processing apparatus 100 in FIG. 3 and further includes an emotion analysis unit 110 and an acquisition unit 114.

The emotion analysis unit 110 performs an emotion analysis of a user U (subject) by using data for emotion analysis of the user U acquired from a wearable terminal 50 of the user U and outputs an emotion analysis result. The emotion analysis unit 110 and the acquisition unit 114 are similar to the emotion analysis unit 110 and the acquisition unit 114 in FIG. 8.

The acquisition unit 114 acquires data for emotion analysis of the user U and acquires task information related to a task in which the user U is engaged in a case where the data for emotion analysis are acquired. The data for emotion analysis include biometric information of the user U acquired from the wearable terminal 50 worn by the user U. The biometric information acquired by the acquisition unit 114 is stored as biometric information 130 (FIG. 9) in a memory 1030 or a storage device 1040 in a computer 1000 implementing a user terminal 60 or a server apparatus 70, or a storage apparatus 120.

The emotion analysis result output from the emotion analysis unit 110 is stored as score history information 140 (FIG. 11) in the memory 1030 or the storage device 1040 in the computer 1000 implementing the user terminal 60 or the server apparatus 70, or the storage apparatus 120.

Furthermore, the emotion analysis unit 110 may estimate whether the emotion of the user U is included in a negative region and determine a case of the user U being estimated to have a negative emotion, similarly to the aforementioned example embodiment,

The storage processing unit 102 may store, as emotion analysis result information 160 (FIG. 13), an emotion analysis result of the user U into the memory 1030 or the storage device 1040 in the computer 1000 implementing the user terminal 60 or the server apparatus 70, or the storage apparatus 120 in association with the category of a task in which the user U is engaged in a case where the user U becomes an analysis target of the emotion analysis result.

Furthermore, for each task category, the emotion analysis unit 110 may determine an emotion score, based on an emotion analysis result of the user U by task category in a predetermined period, similarly to the aforementioned example embodiment. For example, the ratio of the time during which a score value indicating a mental state is included in a positive emotion region or a negative emotion region described above may be determined as an emotion score. More specifically, the ratio of the time during which the user U is estimated to have a positive emotion or a negative emotion to working hours may be determined as an emotion score.

By processing a conversation voice of the user U in a case where the user U becomes an analysis target of an emotion analysis result, the extraction unit 106 extracts a keyword including at least one of a word and a phrase included in the conversation voice.

The display processing unit 104 displays a screen including information in which a classification of the emotion of the user U for a task is associated with a keyword included in a conversation voice during engagement in the task.

For example, the display processing unit 104 may display a keyword included in a conversation voice during a task in at least one type of emotion classifications out of negative emotion classifications “ANGRY” and “SAD” and positive emotion classifications “HAPPY” and “RELAXED.”. As for display switching between a keyword in a negative emotion and a keyword in a positive emotion, a switching operation may be accepted by a radio button (unillustrated) or the like.

Alternatively, for each of the four emotion classifications, the display processing unit 104 may display a keyword included in a conversation voice in the emotion during a task.

FIG. 20 is a functional block diagram illustrating a configuration example of a variant of the information processing apparatus 100 according to the example embodiment.

In this example, the information processing apparatus 100 further includes a counting unit 112 that counts the frequency of appearance by keyword included in a conversation voice during engagement in a task. The display processing unit 104 may arrange keywords in descending order of frequency of appearance and display the keywords on a screen.

While various methods for displaying keywords may be considered, for example, keywords may be displayed in a word cloud format. Specifically, a keyword with a greater frequency of appearance counted by the counting unit 112 may be displayed in larger characters for indicating the keyword or may be displayed in a larger figure enclosing characters indicating the keyword.

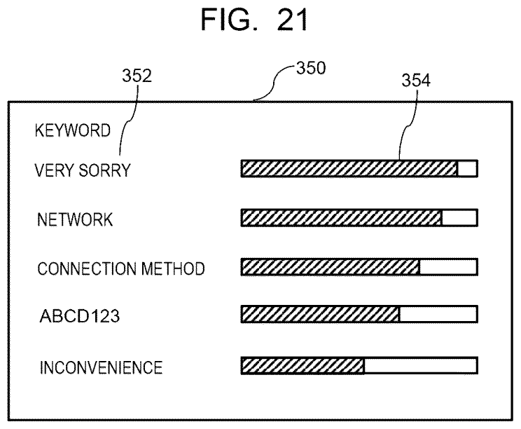

FIG. 21 is a diagram illustrating an example of a keyword ranking screen 350. The keyword ranking screen 350 may be displayed by a display operation of the keyword ranking screen 350 being selected from an operation menu. In this example, the keyword ranking screen 350 includes a keyword display part 352 and an appearance frequency display part 354. A keyword with a higher frequency of appearance is displayed at a higher position in the keyword display part 352. For example, the frequency of appearance included in a conversation voice during a task being a target of the emotion analysis may be displayed in the appearance frequency display part 354, or the ratio of the frequency of appearance of the keyword to the number of all keywords extracted from the conversation voice during the task being the target of the emotion analysis may be displayed.

Further, a region determining a negative emotion classification or a positive emotion classification may be determined by inclusion in a fan-shaped region indicated by a predetermined angle in a classification region for each emotion, similarly to the aforementioned example embodiment.

Examples of function allocation of the information processing apparatus 100 in the user terminal 60 and the server apparatus 70 are as follows.
(b1) All the functions are achieved by the user terminal 60 in the system configuration in FIG. 5 not including the server apparatus 70.

Examples of function allocation in the system configuration in FIG. 6 including the user terminal 60 and the server apparatus 70 are as follows.
(b2) The user terminal 60 achieves the function of acquiring biometric information from the wearable terminal 50 by the acquisition unit 114; and the server apparatus 70 achieves the function of acquiring biometric information from the user terminal 60 by the acquisition unit 114 and the functions of the emotion analysis unit 110, the storage processing unit 102, the extraction unit 106, the counting unit 112, and the display processing unit 104. In other words, the user terminal 60 acquires biometric information from the wearable terminal 50 and transmits the information to the server apparatus 70; and the server apparatus 70 performs emotion analysis processing, speech processing, and the like by using the biometric information received by the user terminal 60, stores and manages information, causes the user terminal 60 to display the keyword ranking screen 350, and causes the user U to browse.
(b3) The user terminal 60 may achieve the functions of the extraction unit 106 and the counting unit 112 out of the functions of the server apparatus 70 in (b2) described above.
(b4) The user terminal 60 may achieve the function of the emotion analysis unit 110 out of the functions of the server apparatus 70 in (b2) described above.
(b5) The user terminal 60 achieves the functions of the acquisition unit 114, the emotion analysis unit 110, the storage processing unit 102, the extraction unit 106, and the counting unit 112 and the function of transmitting an emotion analysis result and the category of a task to the server apparatus 70; and the server apparatus 70 achieves the function of recording the emotion analysis result and the category of the task that are received from the user terminal 60 by the storage processing unit 102 and the function of the display processing unit 104. In other words, the user terminal 60 performs processing up to association of an emotion analysis result with the category of a task, and extraction and counting of keywords; and the server apparatus 70 stores and manages information received by the user terminal 60, causes the user terminal 60 to display the keyword ranking screen 350, and causes the user U to browse.

### Operation Example

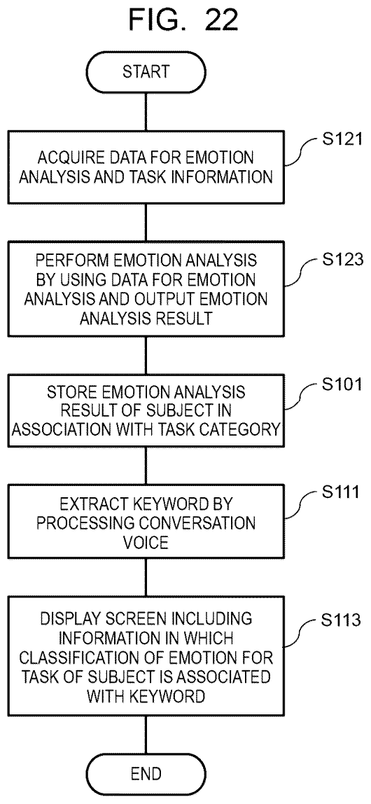

FIG. 22 is a flowchart illustrating an operation example of the information processing apparatus 100 according to the example embodiment. The example of function allocation in (b2) will be described.

The flow in FIG. 22 includes Step S101, Step S111, and Step S113 that are the same as those in the flow in FIG. 4 and further includes Step S121 and Step S123 that are the same as those in the flow in FIG. 18 in the aforementioned example embodiment. Note that each step in the flowchart can be operated independently, and each step may be executed at a different timing as described above.

First, the acquisition unit 114 in the user terminal 60 acquires data for emotion analysis (biometric information) of a user U (Step S121). The acquired biometric information is stored as the biometric information 130 into the memory 1030 or the storage device 1040 in the user terminal 60 in association with time information. The acquisition unit 114 in the server apparatus 70 receives the data for emotion analysis (biometric information 130) of the user U from the user terminal 60 and stores the information into the storage apparatus 120 in association with identification information of the user U.

The acquisition unit 114 in the server apparatus 70 acquires task information 150 related to a task in which the user U is engaged in a case where the data for emotion analysis are acquired (Step S121). Then, the emotion analysis unit 110 in the server apparatus 70 performs an emotion analysis of the user U by using the data for emotion analysis of the user U acquired by the acquisition unit 114 and outputs an emotion analysis result (Step S123).

Then, the storage processing unit 102 in the server apparatus 70 stores, as the emotion analysis result information 160, the emotion analysis result of the user U in association with the category of a task in which the user U is engaged in a case where the user U becomes an analysis target of the emotion analysis result (Step S101).

Then, by processing a conversation voice of the user U in a case where the user U becomes the analysis target of the emotion analysis result, the extraction unit 106 in the server apparatus 70 extracts a keyword including at least one of a word and a phrase included in the conversation voice (Step S111). Then, the display processing unit 104 in the server apparatus 70 displays a screen including information in which a classification of the emotion of the user U for a task is associated with a keyword included in a conversation voice during engagement in the task by category for a task (Step S113).

The display processing unit 104 in the server apparatus 70 displays a screen on a display of the user terminal 60. Alternatively, the display processing unit 104 in the server apparatus 70 may display a screen on a display of a manager terminal 80 described in an example embodiment to be described later.

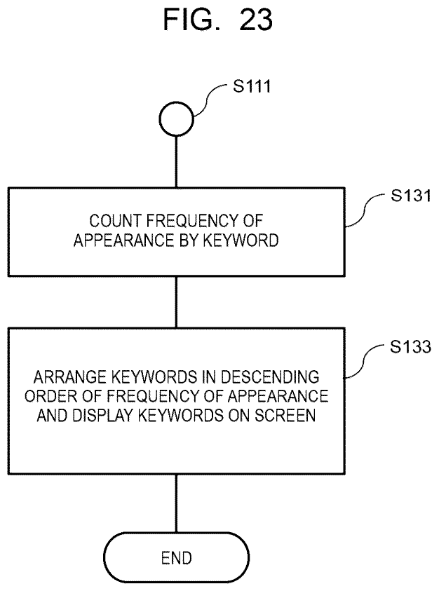

FIG. 23 is a flowchart illustrating processing of counting keywords.

After keywords are extracted from a conversation in the server apparatus 70 in Step S111 in FIG. 22, the counting unit 112 counts a frequency of appearance by keyword (Step S131). Then, the display processing unit 104 in the server apparatus 70 arranges the keywords in descending order of frequency of appearance and displays the keywords on the keyword ranking screen 350 (FIG. 21) (Step S133). The screen is also displayed on the display of at least one of the user terminal 60 and the manager terminal 80.

As described above, the information processing apparatus 100 according to the present example embodiment includes the storage processing unit 102, the display processing unit 104, the extraction unit 106, the emotion analysis unit 110, and the acquisition unit 114.

The emotion analysis unit 110 performs an emotion analysis of a user U (subject) by using data for emotion analysis of the user U acquired from the wearable terminal 50 of the user U and outputs an emotion analysis result. The acquisition unit 114 acquires the data for emotion analysis of the user U and acquires task information related to a task in which the user U is engaged in a case where the data for emotion analysis are acquired. The storage processing unit 102 stores the emotion analysis result of the user U in association with the category of a task in which the user U is engaged in a case where the user U becomes an analysis target of the emotion analysis result or the category of a task indicating a break. By processing a conversation voice of the user U in a case where the user U becomes the analysis target of the emotion analysis result, the extraction unit 106 extracts a keyword including at least one of a word and a phrase included in the conversation voice. The display processing unit 104 displays a screen including information in which a classification of the emotion of the user U for a task is associated with a keyword included in a conversation voice during engagement in the task.

Thus, the information processing apparatus 100 according to the example embodiment can facilitate recognition of an effect of a task of a subject on a mental state by visualizing the emotion of the subject during the task.

### Third Example Embodiment

### System Overview

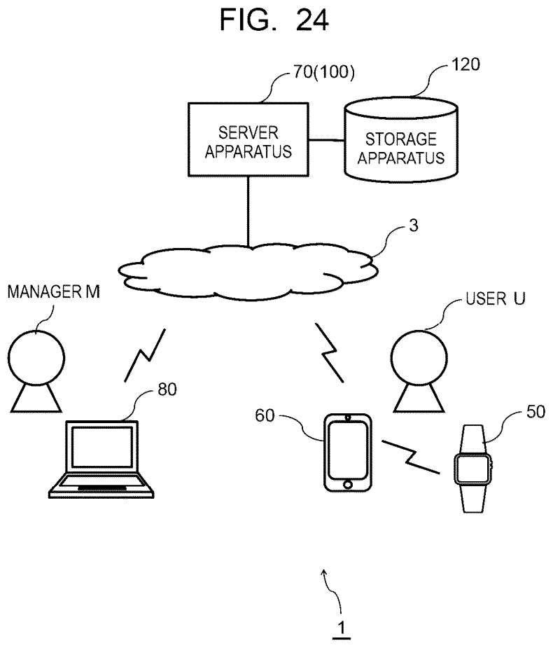

FIG. 24 is a diagram conceptually illustrating an example of a system configuration of an information processing system 1 according to an example embodiment.

The information processing system 1 further includes a manager terminal 80 in addition to the configuration of the information processing system 1 in FIG. 6. For example, the manager terminal 80 is a terminal used by a manager M managing a user U at an enterprise for which the user U works and is a computer 1000 such as a personal computer, a tablet terminal, or a smartphone. The manager terminal 80 can communicate with a user terminal 60 through a communication network 3.

### Functional Configuration Example

The present example embodiment is similar to any of the example embodiments described above except for having a configuration in which various screens displayed by the display processing unit 104 according to the aforementioned example embodiments can also be displayed on the manager terminal 80. The information processing apparatus 100 will be described assuming that the apparatus has the configuration according to the first example embodiment and therefore will be described by using FIG. 8. Note that the configuration according to the present example embodiment may be combined with at least one of configurations according to example embodiments other than the first example embodiment without contradicting each other.

A task according to the present example embodiment includes a call handling task with a customer at a call center. A subject described as a user U in the aforementioned example embodiments is described as an operator in the present example embodiment.

An emotion analysis unit 110 performs an emotion analysis of an operator (subject) on a per-call-handling basis and outputs an emotion analysis result. Note that the emotion analysis unit 110 may perform an emotion analysis of the operator by processing a conversation voice of the operator. Alternatively, the emotion analysis unit 110 may perform an emotion analysis by using biometric information such as a pulse of the operator. In that case, the conversation voice of the operator is used for keyword extraction by an extraction unit 106.

A storage processing unit 102 stores, on a per-call-handling basis, an emotion analysis result of the operator output by the emotion analysis unit 110 into a memory 1030 or a storage device 1040 in the computer 1000 implementing the user terminal 60 or a server apparatus 70, or a storage apparatus 120.

A display processing unit 104 displays, on a per-call-handling basis, a classification of the emotion of the operator during call handling in association with a keyword on a screen (such as a report screen 360 to be described later).

Further, as for function allocation of the information processing apparatus 100 in the user terminal 60 and the server apparatus 70, the example in (b2) described above will be described.

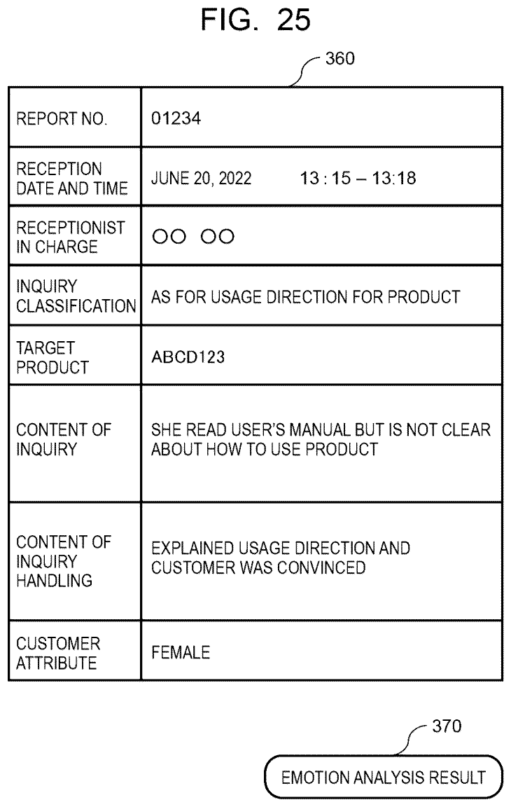

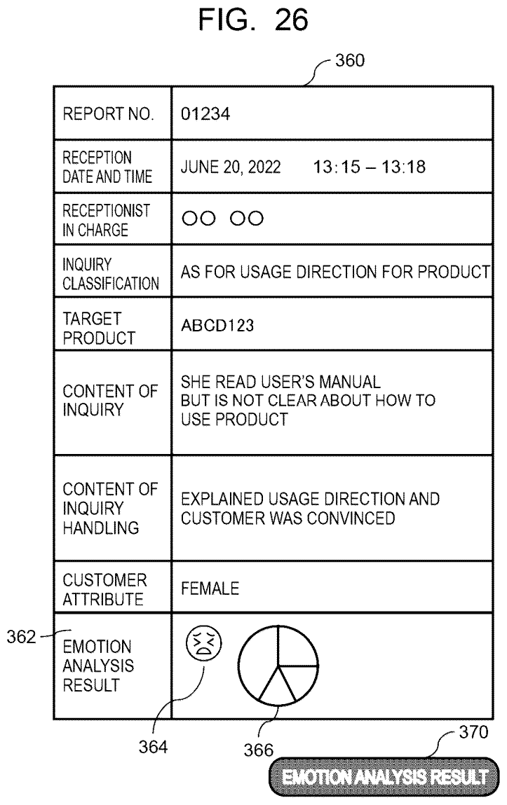

FIG. 25 and FIG. 26 are diagrams illustrating examples of a report screen 360 displayed on a display of the manager terminal 80. Note that the report screen 360 may also be displayed on a display of the user terminal 60. The report screen 360 may be displayed by a display operation of the report screen 360 being selected from an operation menu.

The report screen 360 is a screen for preparing or browsing a report to be submitted in which contents of calls received by an operator at a call center or the like are recorded. For example, the report screen 360 includes a display part displaying information such as identification information of a report (a report number in this case), a date and time at which a call is received, an operator name (receptionist in charge), the classification of an inquiry in the call, a target product of the inquiry (such as a product name or a model number), a content of the inquiry, a content of inquiry handling, the attribute of a customer placing the call (such as a gender or an age group). Note that in the case of an edit screen of a report, the report screen 360 may include a suitable UI, such as a text entry field and a classification selection menu, and be able to accept an operation by a person entering information.

A “keyword” associated with the aforementioned classification of the emotion of the operator corresponds to a keyword included in each of a target product (such as a product name or a model number) of an inquiry, the classification of the inquiry in the call, a content of the inquiry, a content of inquiry handling, and a response content that are displayed on the report screen 360. The display processing unit 104 can display, on the report screen 360, a keyword included in a conversation voice in which the emotion of the operator belongs in the negative emotion classification “ANGRY” or “SAD” in particular in such a way as to allow distinction by at least one of a color and a display element. For example, the display processing unit 104 may change the color of or highlight a keyword included in a conversation voice belonging in a negative emotion classification out of keywords included in a content of an inquiry.

Furthermore, upon accepting depression of an emotion analysis result display button 370, the display processing unit 104 makes a transition to the report screen 360 in FIG. 26.

On the report screen 360 in FIG. 26, an emotion analysis result display part 362 is further added to the report screen 360 in FIG. 25. For example, the emotion analysis result display button 370 on the report screen 360 in FIG. 26 is displayed in a state of being reversed from the emotion analysis result display button 370 in FIG. 25 in order to indicate a selected state.

The display processing unit 104 in the server apparatus 70 displays the classification of an emotion in such a way as to allow distinction by at least one of a color and a display element. For example, at least one of a display element 364 and a score graph 366 is displayed in an emotion analysis result display part 362 on the report screen 360. The display element 364 may be similar to the display element 322 on the schedule screen 300 described above. For example, a display element 364 indicating an emotion classification with the highest ratio during a call may be displayed.

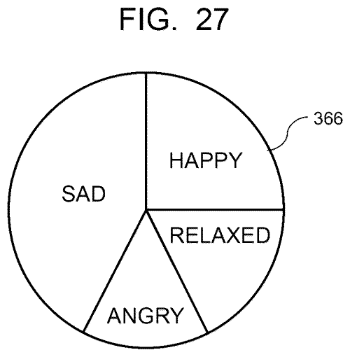

As illustrated in FIG. 27, the score graph 366 is a graph illustrating a distribution of emotions of an operator, based on an emotion analysis result of the operator during a call being the report target. For example, the display processing unit 104 determines a classification of the emotion of the operator during a call, based on score history information 140, measures a time for each emotion classification, and displays the ratio of each emotion classification to the call time indicated in the score graph 366.

As described above, the information processing apparatus 100 according to the present example embodiment includes the storage processing unit 102, the display processing unit 104, the extraction unit 106, the emotion analysis unit 110, and the acquisition unit 114. The emotion analysis unit 110 performs an emotion analysis of an operator on a per-call-handling basis and outputs an emotion analysis result. The storage processing unit 102 stores the emotion analysis result of the user U output by the emotion analysis unit 110 on a per-call-handling basis. The display processing unit 104 displays a screen on which a classification of the emotion of the operator during call handling is associated with a keyword on a per-call-handling basis.

Thus, by visualizing the emotion of an operator during call handling at a call center, the information processing apparatus 100 according to the example embodiment can facilitate recognition of an effect of a task of the operator on a mental state. In particular, since the report screen 360 can be displayed on the manager terminal 80 of a manager M, the manager M can recognize the mental state of the operator in addition to a task report and therefore can take a suitable action.

For example, since a keyword extracted from a conversation during call handling can be displayed in association with an emotion, a keyword causing ups and downs of the emotion of the operator can be estimated. Thus, an element about which the operator feels uneasy by himself/herself can be recognized, and therefore, actions for removing the uneasiness, such as enhancement of learning or training about a field related to the element about which the operator feels uneasy and enrichment of frequently asked questions (FAQ) in a call handling manual, can be taken.

While the example embodiments of the present invention have been described above with reference to the drawings, the example embodiments are examples of the present invention, and various configurations other than those described above may also be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified in each example embodiment without affecting the contents. Further, the aforementioned example embodiments may be combined without contradicting each other.

While the present invention has been described above with reference to the example embodiments, the present invention is not limited to the aforementioned example embodiments. Various changes and modifications that may be understood by a person skilled in the art may be made to the configurations and details of the present invention, within the scope of the present invention.

Note that, in a case where information about a user is acquired and used in the present invention, the acquisition and the use are assumed to be performed legally.

The whole or part of the example embodiments disclosed above may also be described as, but not limited to, the following supplementary notes.
1. An information processing apparatus including:
a storage processing unit that stores an emotion analysis result of a subject into a storage unit in association with a category of a task in which the subject is engaged in a case where the subject becomes an analysis target of the emotion analysis result; and
a display processing unit that displays, on a screen displaying a schedule of the subject, schedules by category of the task which is planned to be performed or has been previously performed, in association with the emotion analysis result related to a category of the task.
2. The information processing apparatus according to 1, wherein
the display processing unit displays the schedules by category of the task in such a way as to allow distinction by a color or a display element based on the emotion analysis result of the subject.
3. The information processing apparatus according to 1 or 2, wherein
the emotion analysis result includes, by category of the task, an emotion score indicating at least one of a degree of positiveness and a degree of negativeness of an emotion of the subject for a task, and
the display processing unit displays a screen indicating a rank of the emotion score of the subject for the each task.
4. The information processing apparatus according to 3, wherein
the display processing unit displays, on a screen for a schedule indicating a future plan, in such a way as to allow distinction by a color or a display element being related to a category of the task and indicating at least one of a degree of positiveness and a degree of negativeness of an emotion of the subject for a task.
5. The information processing apparatus according to any one of 1 to 4, further including
an emotion analysis unit that performs an emotion analysis of the subject by using data for emotion analysis of the subject acquired from a terminal of the subject and outputs the emotion analysis result.
6. An information processing apparatus including:

a storage processing unit that stores an emotion analysis result of a subject into a storage unit in association with a category of a task in which the subject is engaged in a case where the subject becomes an analysis target of the emotion analysis result;
an extraction unit that extracts, by processing a conversation voice of the subject in a case where the subject becomes an analysis target of the emotion analysis result, a keyword which includes at least one of a word and a phrase included in the conversation voice; and
a display processing unit that displays a screen including information in which a classification of an emotion of the subject for the task is associated with the keyword included in the conversation voice during engagement in the task.
7. The information processing apparatus according to 6, further including
a counting unit that counts a frequency of appearance by the keyword included in the conversation voice during engagement in the task, wherein
the display processing unit arranges the keywords in descending order of the frequency of appearance and further displays the keywords on the screen.
8. The information processing apparatus according to 6 or 7, wherein
the task includes a call handling task at a call center with a customer,
the information processing apparatus further includes an emotion analysis unit that performs an emotion analysis of the subject on a per-call-handling basis and outputs an emotion analysis result,
the storage processing unit stores the emotion analysis result of the subject output by the emotion analysis unit into the storage unit on the per-call-handling basis, and
the display processing unit displays, on the per-call-handling basis, the screen on which a classification of the emotion of the subject during the call handling is associated with the keyword.
9. The information processing apparatus according to any one of 6 to 8, wherein
the display processing unit displays a classification of the emotion in such a way as to allow distinction by at least one of a color and a display element.
10. The information processing apparatus according to any one of 1 to 9, further including
an acquisition unit that acquires data for emotion analysis of the subject and acquires task information related to the task in which the subject is engaged in a case where the data for emotion analysis are acquired.
11. An information processing method including, by one or more computers:
storing an emotion analysis result of a subject into a storage unit in association with a category of a task in which the subject is engaged in a case where the subject becomes an analysis target of the emotion analysis result; and
displaying, on a screen displaying a schedule of the subject, schedules by category of the task which is planned to be performed or has been previously performed, in association with the emotion analysis result related to a category of the task.
12. The information processing method according to 11, further including, by the one or more computers,
displaying the schedules by category of the task in such a way as to allow distinction by a color or a display element based on the emotion analysis result of the subject.
13. The information processing method according to 11 or 12, wherein
the emotion analysis result includes, by category of the task, an emotion score indicating at least one of a degree of positiveness and a degree of negativeness of an emotion of the subject for a task, and
the information processing method further includes, by the one or more computers, displaying a screen indicating a rank of the emotion score of the subject for the each task.
14. The information processing method according to 13, further including, by the one or more computers,
displaying, on a screen for a schedule indicating a future plan, in such a way as to allow distinction by a color or a display element being related to a category of the task and indicating at least one of a degree of positiveness and a degree of negativeness of an emotion of the subject for a task.
15. The information processing method according to any one of 11 to 14, further including, by the one or more computers,
performing an emotion analysis of the subject by using data for emotion analysis of the subject acquired from a terminal of the subject and outputs the emotion analysis result.
16. An information processing method including, by one or more computers:
storing an emotion analysis result of a subject into a storage unit in association with a category of a task in which the subject is engaged in a case where the subject becomes an analysis target of the emotion analysis result;
extracting, by processing a conversation voice of the subject during engagement in the task being an analysis target of the emotion analysis result, a keyword which includes at least one of a word and a phrase included in the conversation voice; and
displaying a screen including information in which a classification of an emotion of the subject for the task is associated with the keyword included in the conversation voice during engagement in the task.
17. The information processing method according to 16, further including, by the one or more computers:
counting a frequency of appearance by the keyword included in the conversation voice during engagement in the task; and
arranging the keywords in descending order of the frequency of appearance and further displaying the keywords on the screen.
18. The information processing method according to 16 or 17, wherein
the task includes a call handling task at a call center with a customer, and the information processing method further includes, by the one or more computers:
   performing an emotion analysis of the subject on a per-call-handling basis and outputting an emotion analysis result;
   storing the output emotion analysis result of the subject into the storage unit on the per-call-handling basis; and
   displaying, on the per-call-handling basis, the screen on which a classification of the emotion of the subject during the call handling is associated with the keyword.
19. The information processing method according to any one of 16 to 18, further including, by the one or more computers,
displaying a classification of the emotion in such a way as to allow distinction by at least one of a color and a display element.
20. The information processing method according to any one of 11 to 19, further including, by the one or more computers,
acquiring data for emotion analysis of the subject and acquires task information related to the task in which the subject is engaged in a case where the data for emotion analysis are acquired.
21. A computer-readable medium storing a program for causing a computer to execute:
a procedure for storing an emotion analysis result of a subject into a storage unit in association with a category of a task in which the subject is engaged in a case where the subject becomes an analysis target of the emotion analysis result; and
a procedure for displaying, on a screen displaying a schedule of the subject, schedules by category of the task which is planned to be performed or has been previously performed, in association with the emotion analysis result related to a category of the task.
22. The medium according to 21, storing the program for causing the computer to further execute
a procedure for displaying the schedules by category of the task in such a way as to allow distinction by a color or a display element based on the emotion analysis result of the subject.
23. The medium according to 21 or 22, wherein
the emotion analysis result includes, by category of the task, an emotion score indicating at least one of a degree of positiveness and a degree of negativeness of an emotion of the subject for a task, and
the medium stores the program for causing the computer to further execute a procedure for displaying a screen indicating a rank of the emotion score of the subject for the each task.
24. The medium according to 23, storing the program for causing the computer to further execute
a procedure for displaying, on a screen for a schedule indicating a future plan, in such a way as to allow distinction by a color or a display element being related to a category of the task and indicating at least one of a degree of positiveness and a degree of negativeness of an emotion of the subject for a task.
25. The medium according to any one of 21 to 24, storing the program for causing the computer to further execute
a procedure for performing an emotion analysis of the subject by using data for emotion analysis of the subject acquired from a terminal of the subject and outputting the emotion analysis result.
26. A computer-readable medium storing a program for causing a computer to execute:
a procedure for storing an emotion analysis result of a subject into a storage unit in association with a category of a task in which the subject is engaged in a case where the subject becomes an analysis target of the emotion analysis result;
a procedure for extracting, by processing a conversation voice of the subject during engagement in the task being an analysis target of the emotion analysis result, a keyword which includes at least one of a word and a phrase included in the conversation voice; and
a procedure for displaying a screen including information in which a classification of an emotion of the subject for the task is associated with the keyword included in the conversation voice during engagement in the task.
27. The medium according to 26, storing the program for causing the computer to further execute:
a procedure for counting a frequency of appearance by the keyword included in the conversation voice during engagement in the task; and
a procedure for arranging the keywords in descending order of the frequency of appearance and further displaying the keywords on the screen.
28. The medium according to 26 or 27, wherein
the task includes a call handling task at a call center with a customer, and
the medium stores the program for causing the computer to further execute:
   a procedure for performing an emotion analysis of the subject on a per-call-handling basis and outputting an emotion analysis result;
   a procedure for storing the output emotion analysis result of the subject into the storage unit on the per-call-handling basis; and
   a procedure for displaying, on the per-call-handling basis, the screen on which a classification of the emotion of the subject during the call handling is associated with the keyword.
29. The medium according to any one of 26 to 28, storing the program for causing the computer to further execute
a procedure for displaying a classification of the emotion in such a way as to allow distinction by at least one of a color and a display element.
30. The medium according to any one of 21 to 29, storing the program for causing the computer to further execute
a procedure for acquiring data for emotion analysis of the subject and acquiring task information related to the task in which the subject is engaged in a case where the data for emotion analysis are acquired.
31. A program for causing a computer to execute:
a procedure for storing an emotion analysis result of a subject into a storage unit in association with a category of a task in which the subject is engaged in a case where the subject becomes an analysis target of the emotion analysis result; and
a procedure for displaying, on a screen displaying a schedule of the subject, schedules by category of the task which is planned to be performed or has been previously performed, in association with the emotion analysis result related to a category of the task.
32. The program medium according to 31, for causing the computer to further execute
a procedure for displaying the schedules by category of the task in such a way as to allow distinction by a color or a display element based on the emotion analysis result of the subject.
33. The program according to 31 or 32, wherein
the emotion analysis result includes, by category of the task, an emotion score indicating at least one of a degree of positiveness and a degree of negativeness of an emotion of the subject for a task, and
the program is for causing the computer to further execute a procedure for displaying a screen indicating a rank of the emotion score of the subject for the each task.
34. The program according to 33, for causing the computer to further execute
a procedure for displaying, on a screen for a schedule indicating a future plan, in such a way as to allow distinction by a color or a display element being related to a category of the task and indicating at least one of a degree of positiveness and a degree of negativeness of an emotion of the subject for a task.
35. The program according to any one of 31 to 34, for causing the computer to further
a procedure for performing an emotion analysis of the subject by using data for emotion analysis of the subject acquired from a terminal of the subject and outputting the emotion analysis result.
36. A program for causing a computer to execute:
a procedure for storing an emotion analysis result of a subject into a storage unit in association with a category of a task in which the subject is engaged in a case where the subject becomes an analysis target of the emotion analysis result;
a procedure for extracting, by processing a conversation voice of the subject during engagement in the task being an analysis target of the emotion analysis result, a keyword which includes at least one of a word and a phrase included in the conversation voice; and
a procedure for displaying a screen including information in which a classification of an emotion of the subject for the task is associated with the keyword included in the conversation voice during engagement in the task.
37. The program according to 36, for causing the computer to further execute:
a procedure for counting a frequency of appearance by the keyword included in the conversation voice during engagement in the task; and
a procedure for arranging the keywords in descending order of the frequency of appearance and further displaying the keywords on the screen.
38. The program according to 36 or 37, wherein
the task includes a call handling task at a call center with a customer, and
the program is for causing the computer to further execute:
   a procedure for performing an emotion analysis of the subject on a per-call-handling basis and outputting an emotion analysis result;
   a procedure for storing the output emotion analysis result of the subject into the storage unit on the per-call-handling basis; and
   a procedure for displaying, on the per-call-handling basis, the screen on which a classification of the emotion of the subject during the call handling is associated with the keyword.
39. The program according to any one of 36 to 38, for causing the computer to further execute
a procedure for displaying a classification of the emotion in such a way as to allow distinction by at least one of a color and a display element.
40. The program according to any one of 31 to 39, for causing the computer to further execute
a procedure for acquiring data for emotion analysis of the subject and acquiring task information related to the task in which the subject is engaged in a case where the data for emotion analysis are acquired.

### REFERENCE SIGNS LIST

1 Information processing system
3 Communication network
50 Wearable terminal
60 User terminal
70 Server apparatus
80 Manager terminal
100 Information processing apparatus
102 Storage processing unit
104 Display processing unit
106 Extraction unit
110 Emotion analysis unit
112 Counting unit
114 Acquisition unit
120 Storage apparatus
130 Biometric information
140 Score history information
150 Task information
160 Emotion analysis result information
170 Task-by-task emotion information
300 Schedule screen
310 Legend list
320 Emotion analysis result display button
330 Task ranking screen
350 Keyword ranking screen
360 Report screen
362 Emotion analysis result display part
364 Display element
366 Score graph
370 Emotion analysis result display button
1000 Computer
1020 Processor
1030 Memory
1040 Storage device
1050 Input/output interface
1060 Network interface

What is claimed is:

1. An information processing apparatus comprising:
at least one memory storing instructions; and
at least one processor configured to execute the instructions to:
store an emotion analysis result of a subject into a storage unit in association with a category of a task in which the subject is engaged in a case where the subject becomes an analysis target of the emotion analysis result; and
display on a screen displaying a schedule of the subject, schedules by category of the task which is planned to be performed or has been previously performed, in association with the emotion analysis result related to a category of the task.

2. The information processing apparatus according to claim 1, wherein the at least one processor is further configured to execute the instructions to
display the schedules by category of the task in such a way as to allow distinction by a color or a display element according to the emotion analysis result of the subject.

3. The information processing apparatus according to claim 1, wherein
the emotion analysis result includes, by category of the task, an emotion score indicating at least one of a degree of positiveness and a degree of negativeness of an emotion of the subject for a task, and
the at least one processor is further configured to execute the instructions to
display a screen indicating a rank of the emotion score of the subject for the each task.

4. The information processing apparatus according to claim 3, wherein the at least one processor is further configured to execute the instructions to
display, on a screen for a schedule indicating a future plan, a schedule in such a way as to allow distinction by a color or a display element being related to a category of the task and indicating at least one of a degree of positiveness and a degree of negativeness of an emotion of the subject for a task.

5. The information processing apparatus according to claim 1, wherein the at least one processor is further configured to execute the instructions to
perform an emotion analysis of the subject by using data for emotion analysis of the subject acquired from a terminal of the subject and output the emotion analysis result.

6.-9. (canceled)

10. The information processing apparatus according to claim 1, wherein the at least one processor is further configured to execute the instructions to
acquire data for emotion analysis of the subject and acquire task information related to the task in which the subject is engaged when the data for emotion analysis are acquired.

11. An information processing method comprising, by one or more computers:
storing an emotion analysis result of a subject into a storage unit in association with a category of a task in which the subject is engaged in a case where the subject becomes an analysis target of the emotion analysis result; and
displaying, on a screen displaying a schedule of the subject, schedules by category of the task which is planned to be performed or has been previously performed, in association with the emotion analysis result related to a category of the task.

12. The information processing method according to claim 11, further comprising, by the one or more computers,
displaying the schedules by category of the task in such a way as to allow distinction by a color or a display element based on the emotion analysis result of the subject.

13. The information processing method according to claim 11, wherein
the emotion analysis result includes, by category of the task, an emotion score indicating at least one of a degree of positiveness and a degree of negativeness of an emotion of the subject for a task, and
the information processing method further comprises, by the one or more computers, displaying a screen indicating a rank of the emotion score of the subject for the each task.

14. The information processing method according to claim 13, further comprising, by the one or more computers,
displaying, on a screen for a schedule indicating a future plan, a schedule in such a way as to allow distinction by a color or a display element being related to a category of the task and indicating at least one of a degree of positiveness and a degree of negativeness of an emotion of the subject for a task.

15. The information processing method according to claim 11, further comprising, by the one or more computers,
performing an emotion analysis of the subject by using data for emotion analysis of the subject acquired from a terminal of the subject and outputs the emotion analysis result.

16.-19. (canceled)

20. The information processing method according to claim 11, further comprising, by the one or more computers,
acquiring data for emotion analysis of the subject and acquires task information related to the task in which the subject is engaged in a case where the data for emotion analysis are acquired.

21. A non-transitory computer-readable medium storing a program for causing a computer to execute:
a procedure for storing an emotion analysis result of a subject into a storage unit in association with a category of a task in which the subject is engaged in a case where the subject becomes an analysis target of the emotion analysis result; and
a procedure for displaying, on a screen displaying a schedule of the subject, schedules by category of the task which is planned to be performed or has been previously performed, in association with the emotion analysis result related to a category of the task.

22. The non-transitory computer-readable medium according to claim 21, storing the program for causing the computer to further execute
a procedure for displaying the schedules by category of the task in such a way as to allow distinction by a color or a display element based on the emotion analysis result of the subject.

23. The non-transitory computer-readable medium according to claim 21, wherein
the emotion analysis result includes, by category of the task, an emotion score indicating at least one of a degree of positiveness and a degree of negativeness of an emotion of the subject for a task, and
the medium stores the program for causing the computer to further execute a procedure for displaying a screen indicating a rank of the emotion score of the subject for the each task.

24. The non-transitory computer-readable medium according to claim 23, storing the program for causing the computer to further execute
a procedure for displaying, on a screen for a schedule indicating a future plan, a schedule in such a way as to allow distinction by a color or a display element being related to a category of the task and indicating at least one of a degree of positiveness and a degree of negativeeness of an emotion of the subject for a task.

25. The non-transitory computer-readable medium according to claim 21, storing the program for causing the computer to further execute
a procedure for performing an emotion analysis of the subject by using data for emotion analysis of the subject acquired from a terminal of the subject and outputting the emotion analysis result.

26.-30. (canceled)

31. The information processing apparatus according to claim 1, wherein the at least one processor is further configured to execute the instructions to:
extract, by processing a conversation voice of the subject at the time when the subject becomes the analysis target of the emotion analysis result, a keyword which includes at least one of a word and a phrase included in the conversation voice; and
display a screen including information in which a classification of an emotion of the subject for the task is associated with the keyword included in the conversation voice during engagement in the task.

32. The information processing method according to claim 11, further comprising, by the one or more computers:
extracting, by processing a conversation voice of the subject during engagement in the task being an analysis target of the emotion analysis result, a keyword which includes at least one of a word and a phrase included in the conversation voice; and
displaying a screen including information in which a classification of an emotion of the subject for the task is associated with the keyword included in the conversation voice during engagement in the task.

33. The non-transitory computer-readable medium according to claim 21, storing the program for causing the computer to further execute:
a procedure for extracting, by processing a conversation voice of the subject during engagement in the task being an analysis target of the emotion analysis result, a keyword which includes at least one of a word and a phrase included in the conversation voice; and
a procedure for displaying a screen including information in which a classification of an emotion of the subject for the task is associated with the keyword included in the conversation voice during engagement in the task.
